(19) United States
(12) Patent Application Publication
(10) Pub. No.: US 2012/0062537 A1
(43) Pub. Date: Mar. 15, 2012

(54) LIQUID CRYSTAL DISPLAY

(75) Inventors: Youn-Hak JEONG, Cheonan-si (KR); Keun-Chan OH, Cheonan-si (KR); Hee-Hwan LEE, Busan Metropolitan City (KR); Jae-Jin LYU, Yongin-si (KR); Gi-Chang LEE, Seoul (KR)

(73) Assignee: SAMSUNG ELECTRONICS CO., LTD., Suwon-si, (KR)

(21) Appl. No.: 13/215,286

(22) Filed: Aug. 23, 2011

(30) Foreign Application Priority Data
Sep. 15, 2010 (KR) 10-2010-0090590

(51) Int. Cl. G09G 5/00; G09G 3/36

(52) U.S. Cl. 345/211; 345/87

(57) ABSTRACT

A liquid crystal display includes a first substrate and a second substrate facing each other, a liquid crystal layer interposed between the first and second substrates and including liquid crystal molecules, a first gate line and a second gate line formed on the first substrate and transferring gate signals, a first voltage line formed on the first substrate and transferring voltage of predetermined intensity, a data line formed on the first substrate and transferring a data signal, a first switching element connected to the first gate line and the first voltage line, a second switching element connected to the second gate line and the data line, and a pixel electrode connected to the first switching element and the second switching element. A gate-on signal is applied to the first gate line earlier than the second gate line.

This application claims priority to Korean Patent Application No. 10-2010-0090590, filed on Sep. 15, 2010, and all the benefits accruing therefrom under 35 U.S.C. §119, the contents of which in their entirety are herein incorporated by reference.

### BACKGROUND OF THE INVENTION

(a) Field of the Invention

The present invention relates to a liquid crystal display (“LCD”). More particularly, the present invention relates to an LCD having improved display quality.

(b) Description of the Related Art

An LCD, as a type of flat panel display that is being most widely used at present, includes two display panels where electric field generating electrodes such as a pixel electrode and a common electrode are formed and a liquid crystal layer interposed therebetween. The LCD generates an electric field in the liquid crystal layer by applying voltage to the electric field generating electrodes, and through the electric field, determines an orientation of liquid crystal molecules of the liquid crystal layer and controls polarization of incident light to thereby display an image.

In order to display a high-speed moving picture and the like by using the LCD, since data voltage is applied for a short time, the data voltage may not be sufficiently charged in high-speed driving.

Like this, in the case in which the data voltage is not sufficiently charged, a desired image is not sufficiently displayed.

### BRIEF SUMMARY OF THE INVENTION

The present invention provides a liquid crystal display (“LCD”) having advantages of improving a display quality by sufficiently charging data voltage with a desired value while driving the LCD at high speed.

An exemplary embodiment of the present invention provides an LCD including a first substrate and a second substrate facing each other; a liquid crystal layer interposed between the first and second substrates and including liquid crystal molecules; a first gate line and a second gate line formed on the first substrate and transferring gate signals; a first voltage line formed on the first substrate and transferring voltage of predetermined intensity; a data line formed on the first substrate and transferring a data signal; a first switching element connected to the first gate line and the first voltage line; a second switching element connected to the second gate line and the data line; and a pixel electrode connected to the first switching element and the second switching element, wherein a gate-on signal is applied to the first gate line earlier than the second gate line.

The first gate line may be connected to a gate line disposed at the previous stage.

Polarities of voltages that flow on the first voltage line and the data line may be the same as each other.

The intensity of the voltage that flows on the first voltage line may be about 0.9 to about 1.0 times larger than that of the voltage that flows on the data line.

The pixel electrode may include a first pixel electrode and a second pixel electrode, and the intensity of voltage charged in the first pixel electrode may be larger than that of voltage charged in the second pixel electrode.

The first voltage line may be parallel to the first gate line and the second gate line.

Alternatively, the first voltage line may be parallel to the data line.

One first voltage line may be disposed in every a plurality of pixels.

In another exemplary embodiment of the present invention, an LCD includes a first substrate and a second substrate facing each other; a liquid crystal layer interposed between the first and second substrates and including liquid crystal molecules; a first gate line and a second gate line formed on the first substrate and transferring gate signals; a first voltage line formed on the first substrate and transferring voltage of predetermined intensity; a data line formed on the first substrate and transferring a data signal; a first switching element connected to the first gate line and the data line; a second switching element connected to the second gate line and the first voltage line; a pixel electrode connected to the first switching element; and a capacitor connected to the pixel electrode and the second switching element, wherein after a gate-on signal is applied to the first gate line, the gate-on signal is applied to the second gate line.

The pixel electrode may include a first pixel electrode and a second pixel electrode, and the intensity of voltage charged in the first pixel electrode may be larger than that of voltage charged in the second pixel electrode. The capacitor may include a first capacitor including the first pixel electrode and the first voltage line as both terminals and a second capacitor including the second pixel electrode and the second voltage line as both terminals.

The size of the first pixel electrode may be smaller than that of the second pixel electrode, and a ratio of the capacitance of the first capacitor to an area of the first pixel electrode may be about 1.2 times larger than a ratio of the capacitance of the second capacitor to an area of the second pixel electrode.

The LCD may further include: a second voltage line transferring voltage of predetermined intensity having a polarity different from the voltage which the first voltage line transfers; and a third switching element connected to the first gate line and the second voltage line, wherein an output terminal of the third switching element may be connected to a capacitor of an adjacent pixel.

Polarities of voltages that flow on the first voltage line and the data line may be the same as each other.

In yet another exemplary embodiment of the present invention, an LCD includes: a first substrate and a second substrate facing each other; a liquid crystal layer interposed between the first and second substrates and including liquid crystal molecules; a gate line formed on the first substrate and transferring gate signals; a first voltage line formed on the first substrate and transferring voltage of predetermined intensity; a data line formed on the first substrate and transferring a data signal; a first switching element connected to the gate line and the data line; a second switching element connected to the gate line and the first voltage line; a pixel electrode connected to the first switching element; and a capacitor connected to the pixel electrode and the second switching element.

According to exemplary embodiments of the present invention, it is possible to charge data voltage of sufficient intensity even in high-speed driving by precharging with predetermined voltage before applying actual data voltage.

Further, by applying boosting voltage by using a boosting capacitor after applying the actual data voltage, it is possible to charge the data voltage of the sufficient intensity even when a charging time is insufficient by high-speed driving.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a waveform diagram of a signal applied to an exemplary embodiment of a liquid crystal display (“LCD”) according to the present invention;

FIG. 2 is a waveform diagram of a signal applied to another exemplary embodiment of an LCD according to the present invention;

FIG. 3 is an equivalent circuit diagram of an exemplary embodiment of a plurality of adjacent pixels of an LCD according to the present invention;

FIG. 4 is a plan view of an exemplary embodiment of one pixel of the LCD shown in FIG. 3;

FIG. 5 is an equivalent circuit diagram of an exemplary embodiment of a plurality of adjacent pixels of an LCD according to the present invention;

FIG. 6 is a plan view of an exemplary embodiment of some pixels of the LCD shown in FIG. 5;

FIG. 7 is a waveform diagram of a signal applied to an exemplary embodiment of an LCD according to the present invention;

FIG. 8 is an equivalent circuit diagram of an exemplary embodiment of one pixel of the LCD shown in FIG. 7;

FIG. 9 is a plan view of an exemplary embodiment of three pixels of the LCD shown in FIG. 8;

FIG. 10 is an equivalent circuit diagram of an exemplary embodiment of one pixel of an LCD according to the present invention;

FIG. 11 is a plan view of an exemplary embodiment of three pixels of the LCD shown in FIG. 10;

FIG. 12 is an equivalent circuit diagram of another exemplary embodiment of one pixel of an LCD according to the present invention;

FIG. 13 is a plan view of an exemplary embodiment of three pixels of the LCD shown in FIG. 12;

FIG. 14 is an equivalent circuit diagram of another exemplary embodiment of one pixel of an LCD according to the present invention;

FIG. 15 is an equivalent circuit diagram of another exemplary embodiment of one pixel of an LCD according to the present invention;

FIG. 16 is an equivalent circuit diagram of another exemplary embodiment of one pixel of an LCD according to the present invention; and

FIG. 17 is an equivalent circuit diagram of another exemplary embodiment of one pixel of an LCD according to the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Rather, these embodiments are provided so that this disclosure will be thorough and complete, and will fully convey the scope of the invention to those skilled in the art. Like reference numerals refer to like elements throughout.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element′s relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described in detail with reference to the accompanying drawings.

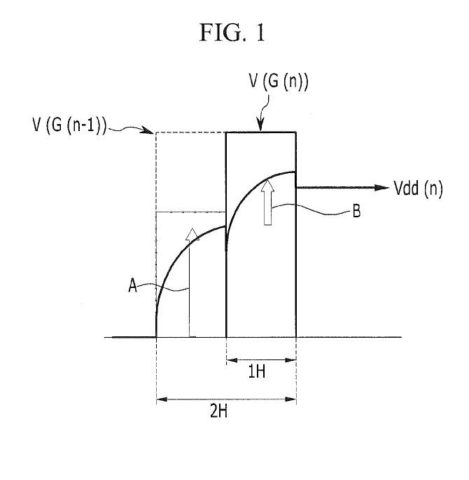

A signal applied to a liquid crystal display (“LCD”) according to an exemplary embodiment of the present invention will be described with reference to FIG. 1. FIG. 1 is a waveform diagram of a signal applied to an exemplary embodiment of an LCD according to the present invention.

Referring to FIG. 1, during a horizontal section 1H immediately before a horizontal section 1H where a gate-on signal V(G(n)) is applied to a first gate line G(n), precharge voltage A is applied to a pixel electrode of a current pixel. The precharge voltage A is applied from a first voltage line to which voltage of predetermined intensity is applied. Thereafter, the gate-on signal V(G(n)) is applied to the first gate line G(n) and data voltage is applied to the current pixel electrode. In this case, since the precharge voltage is applied to and precharged in the current pixel electrode before desired data voltage is charged, voltage B of predetermined intensity corresponding to the difference between a desired data value and the precharge voltage A is charged to charge the current pixel electrode with up to the desired data voltage Vdd. As a result, a time when the pixel voltage is charged in the current pixel decreases.

In an exemplary embodiment in which the data voltage Vd is frame-inverted, the precharge voltage A may be frame-inverted like the data voltage. That is, when the data voltage has a positive polarity, the precharge voltage A may also the positive polarity and when the data voltage has a negative polarity, the precharge voltage A may also have the negative polarity.

The intensity of the precharge voltage A is preferably about 0.9 to about 1.0 as large as that of the data voltage.

By the LCD according to an exemplary embodiment, the precharge voltage A is applied from the first voltage line to which the voltage of the predetermined intensity is applied. Although a voltage line and a driver for applying the precharge voltage A are added, since the precharge voltage A has the predetermined intensity, only a simple driver for applying predetermined voltage is added. As a result, a driving method is simple and a manufacturing cost may be small.

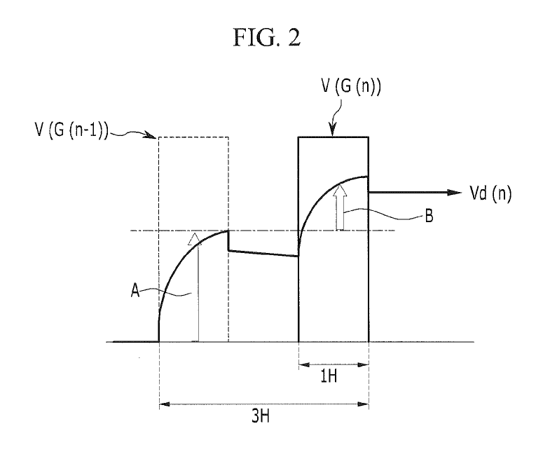

Hereinafter, an applied signal according to another exemplary embodiment of the present invention will be described with reference to FIG. 2. FIG. 2 is a waveform diagram of a signal applied to another exemplary embodiment of an LCD according to the present invention.

Referring to FIG. 2, the signal applied to the exemplary embodiment of the LCD is similar to the signal applied to the exemplary LCD shown in FIG. 1. During a horizontal section 1H before a horizontal section 1H where a gate-on signal V(G(n)) is applied to a first gate line G(n), precharge voltage A is applied to a pixel electrode of a current pixel. The precharge voltage A is applied from a first voltage line to which voltage of predetermined intensity B is applied. Thereafter, the gate-on signal V(G(n)) is applied to the first gate line G(n) and data voltage is applied to the current pixel electrode. In this case, since the precharge voltage A is applied to and precharged in the current pixel electrode before desired data voltage Vdd is charged, voltage B of predetermined intensity corresponding to the difference between a desired data value Vdd and the precharge voltage A is charged to charge the current pixel electrode with up to the desired data value Vdd. As a result, a time when the pixel voltage is charged in the current pixel decreases.

However, unlike the exemplary embodiment shown in FIG. 1, in the case of the precharge voltage A applied to the LCD according to the exemplary embodiment, the precharge voltage A is not applied during the horizontal section immediately before the horizontal section 1H where the gate-on signal V(G(n)) is applied to the first gate line G(n) but the precharge voltage A is applied to the pixel electrode of the current pixel two horizontal sections before the horizontal section 1H where the gate-on signal V(G(n)) is applied to the first gate line G(n).

In an exemplary embodiment in which the data voltage Vd is frame-inverted, the precharge voltage A may be frame-inverted like the data voltage. That is, when the data voltage has a positive polarity, the precharge voltage may also have the positive polarity and when the data voltage has a negative polarity, the precharge voltage may also have the negative polarity.

By the LCD according to the exemplary embodiment, the precharge voltage A is applied from the first voltage line to which the voltage of the predetermined intensity is applied. Although a voltage line and a driver for applying the precharge voltage A are added, since the precharge voltage A has the predetermined intensity, only a simple driver for applying predetermined voltage is added. As a result, a driving method is simple and a manufacturing cost may be small.

The exemplary embodiments shown in FIGS. 1 and 2 are merely examples of the present invention, and the precharge voltage may be applied during a predetermined horizontal section before a horizontal section where the gate-on signal is applied to the gate line that is connected to the current pixel electrode to apply the data voltage.

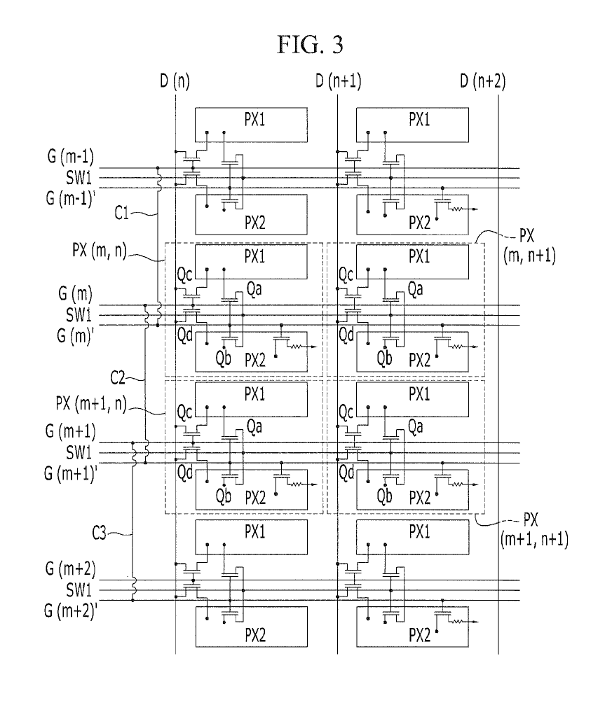

Hereinafter, referring to FIG. 3, an exemplary embodiment of layouts of signal lines and pixels of the LCD according to the present invention and an exemplary embodiment of a driving method thereof will be described. FIG. 3 is an equivalent circuit diagram of an exemplary embodiment of a plurality of adjacent pixels of an LCD according to the present invention.

Referring to FIG. 3, the LCD according to the exemplary embodiment includes a plurality of first pixels PX(m, n) and a plurality of second pixels PX(m, n+1) that are adjacent to each other in a row direction of the pixels, a plurality of third pixels PX(m+1, n) and a plurality of fourth pixels PX(m+1, n+1) that are adjacent to each other in a row direction of the pixels and that are adjacent to the plurality of first pixels PX(m, n) and the plurality of second pixels PX(m, n+1) in a column direction of the pixels, and a plurality of signal lines G(m−1), G(m), G(m+1), G(m+2), G(m−1)′, G(m)′, G(m+1)′, G(m+2)′, D(n), D(n+1), D(n+2), and SW1 that are connected thereto.

The signal lines G(m−1), G(m), G(m+1), G(m+2), G(m−1)′, G(m)′, G(m+1)′, G(m+2)′, D(n), D(n+1), D(n+2), and SW1 include a plurality of gate lines G(m−1), G(m), G(m+1), G(m+2), G(m−1)′, G(m)′, G(m+1)′, G(m+2)′ transferring a gate signal (also referred to as a “scan signal”), a plurality of data lines D(n), D(n+1), D(n+2) transferring data voltage, and a first voltage line SW1 for transferring the precharge voltage. The gate lines G(m−1), G(m), G(m+1), G(m+2), G(m−1)′, G(m)′, G(m+1)′, and G(m+2)′ include a plurality of pairs of gate lines G(m−1) and G(m−1)′, G(m) and G(m)′, G(m+1) and G(m+1)′, and G(m+2) and G(m+2)′ that are connected to the pixels.

The first pixel PX(m, n) is connected to an m (m is a natural number)-th pair of gate lines G(m) and G(m)′ among G(m−1) and G(m−1)′, G(m) and G(m)′, G(m+1) and G(m+1)′, and G(m+2) and G(m+2)′, an n (n is a natural number)-th data line D(n) among the plurality of data lines D(n), D(n+1), and D(n+2), and the first voltage line SW1. The first pixel PX(m, n) includes a first switching element Qa, a second switching element Qb, a third switching element Qc, and a fourth switching element Qd that are connected to the signal lines G(m) and G(m)′, D(n), and SW1, and a first pixel electrode PX1 and a second pixel electrode PX2 connected thereto.

The first switching element Qa, the second switching element Qb, the third switching element Qc, and the fourth switching element Qd are three-terminal elements such as a thin film transistor (“TFT”), and the like. A control terminal of the first switching element Qa is connected to the first gate line G(m)′, an input terminal of the first switching element Qa is connected to the first voltage line SW1, and an output terminal of the first switching element Qa is connected to the first pixel electrode PX1. A control terminal of the second switching element Qb is connected to the first gate line G(m)′, an input terminal of the second switching element Qb is connected to the first voltage line SW1, and an output terminal of the second switching element Qb is connected to the second pixel electrode PX2.

A control terminal of the third switching element Qc is connected to the second gate line G(m), an input terminal of the third switching element Qc is connected to the data line D(n), and an output terminal of the third switching element Qc is connected to the first pixel electrode PX1. A control terminal of the fourth switching element Qd is connected to the second gate line G(m), an input terminal of the fourth switching element Qd is connected to the data line D(n), and an output terminal of the fourth switching element Qd is connected to the second pixel electrode PX2. In an exemplary embodiment, the control terminal, input terminal, and output terminal of the first, second, third, and fourth switching elements Qa, Qb, Qc, and Qd may be a gate electrode, a source electrode, and a drain electrode, respectively.

Although not shown, the first pixel electrode PX1 and the second pixel electrode PX2 are the other terminals of a liquid crystal capacitor Clc having a common electrode (not shown) receiving common voltage Vcom as one terminal. A liquid crystal layer between the first pixel electrode PX1 and the second pixel electrode PX2 and the common electrode serves as a dielectric.

The first gate lines G(m−1)′, G(m)′, G(m+1)′, and G(m+2)′ among each pair of gate lines G(m−1) and G(m−1)′, G(m) and G(m)′, G(m+1) and G(m+1)′, and G(m+2) and G(m+2)′ are the gate lines for activating the switching elements for applying the precharge voltage to the pixels and the second gate lines G(m−1), G(m), G(m+1), and G(m+2) are the gate lines for activating the switching element for applying the data voltage to the pixels.

The first gate lines G(m)′, G(m+1)′, and G(m+2)′ connected to the pixels are connected to the second gate lines G(m−1), G(m), and G(m+1) that are disposed at previous stages through connectors C1, C2, and C3, respectively.

Since connection relationships of the second pixel PX(m, n+1), the third pixel PX(m+1, n), and the fourth pixel PX(m+1, n+1) may be similar to the first pixel PX(m, n), a detailed description thereof will be omitted.

Hereinafter, referring to FIGS. 1 and 3, an exemplary embodiment of a driving method of the exemplary LCD will be described. Referring to FIGS. 1 and 3, the first gate line G(m)′ of the first pixel PX(m, n) is connected to the second gate line G(m−1) of the previous stage through the connector C1. Therefore, during the first horizontal section where the gate-on signal V(G(n)) is applied to the second gate line G(m−1), the gate-on signal V(G(n)) is also applied to the first switching element Qa and the second switching element Qb that are connected to the first pixel PX(m, n), such that the precharge voltage A that flows on the first voltage line SW1 is applied to the pixel electrodes PX1 and PX2 to charge the liquid crystal capacitor of the first pixel PX(m, n) with the precharge voltage A. Thereafter, when the second horizontal section, where the gate-on signal V(G(n)) is applied to the second gate line G(m) of the first pixel PX(m, n), starts after the first horizontal section ends, the gate-on signal V(G(n)) is applied to the third switching element Qc and the fourth switching element Qd that are connected to the second gate line G(m) to apply the data voltage that flows on the first data line D(n) to the pixel electrodes PX1 and PX2. In this case, since the liquid crystal capacitor is precharged with the precharge voltage A, up to a desired data value may be charged by charging only the voltage B of the predetermined intensity corresponding to the difference between a desired data value and the precharged precharge voltage A in order to charge with the data voltage of the desired intensity. Therefore, a time when the pixel is charged with pixel voltage of desired intensity is reduced.

Further, since a previous-stage gate line is used to apply the precharge voltage without an additional gate driver, only the voltage line for transferring the precharge voltage and the simple driver for applying constant precharge voltage may be added without a complicated driver for applying the precharge voltage. As a result, the driving method may be simpler and a manufacturing cost may be decreased.

Although not shown, any one of the first pixel electrode PX1 and the second pixel electrode PX2 that are disposed in each pixel may include a voltage reducing unit or a voltage boosting unit for decreasing or increasing the intensity of charged voltage. As the voltage reducing unit or the voltage boosting unit, all possible structures including a capacitor, a resistor, a charging unit connected with the switching element, and the like may be used.

The intensity of the voltage charged in the first pixel electrode PX1 and the second pixel electrode PX2 disposed in each pixel may vary by including the voltage reducing unit or the voltage boosting unit. Therefore, the side visibility of an LCD of a vertically aligned mode in which long axes of liquid crystal molecules are arranged vertical to a display plate while no electric field is applied may be close to the front visibility.

In the shown exemplary embodiment, the first gate line for applying the precharge voltage is connected to the second gate line of the immediately previous stage, however in alternative exemplary embodiments, the first gate line may be connected to a predetermined previous-stage gate line. For example, a first gate line of an m-th pixel may be connected to second gate lines of m−1, m−2, m−3-th pixels, and the like.

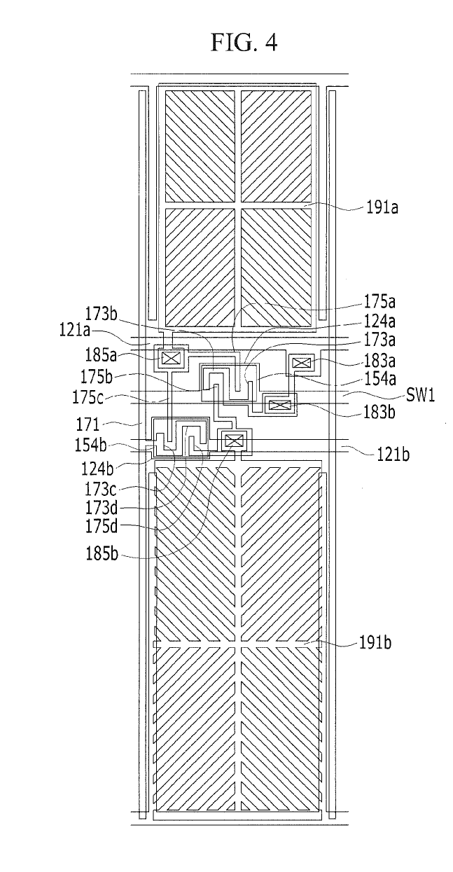

Hereinafter, referring to FIG. 4, an exemplary embodiment of a structure of the exemplary LCD shown in FIG. 3 will be described in brief. FIG. 4 is a plan view of an exemplary embodiment of one pixel of the exemplary LCD shown in FIG. 3.

Referring to FIG. 4, each pixel includes a first pixel electrode 191a and a second pixel electrode 191b, and includes a data line 171, a first gate line 121a and a second gate line 121b, and a first voltage line SW1 that are connected to the first pixel electrode 191a and the second pixel electrode 191b. Further, each pixel includes a first gate electrode 124a, a first source electrode 173a and a second source electrode 173b, a first drain electrode 175a and a second drain electrode 175b, and a first semiconductor 154a that form the first switching element Qa and the second switching element Qb for applying the precharge voltage from the first voltage line SW1 to the first pixel electrode 191a and the second pixel electrode 191b, and includes a second gate electrode 124b, a third source electrode 173c and a fourth source electrode 173d, a third drain electrode 175c and a fourth drain electrode 175d, and a second semiconductor 154b that form the third switching element Qc and the fourth switching element Qd for applying the data voltage from the data line 171 to the first pixel electrode 191a and the second pixel electrode 191b. The first drain electrode 175a and the second drain electrode 175b and the third drain electrode 175c and the fourth drain electrode 175d are connected to the first pixel electrode 191a and the second pixel electrode 191b through a first contact hole 185a and a second contact hole 185b. The first drain electrode 175a and the second drain electrode 175b and the first voltage line SW1 are connected to each other through a third contact hole 183a and a fourth contact hole 183b.

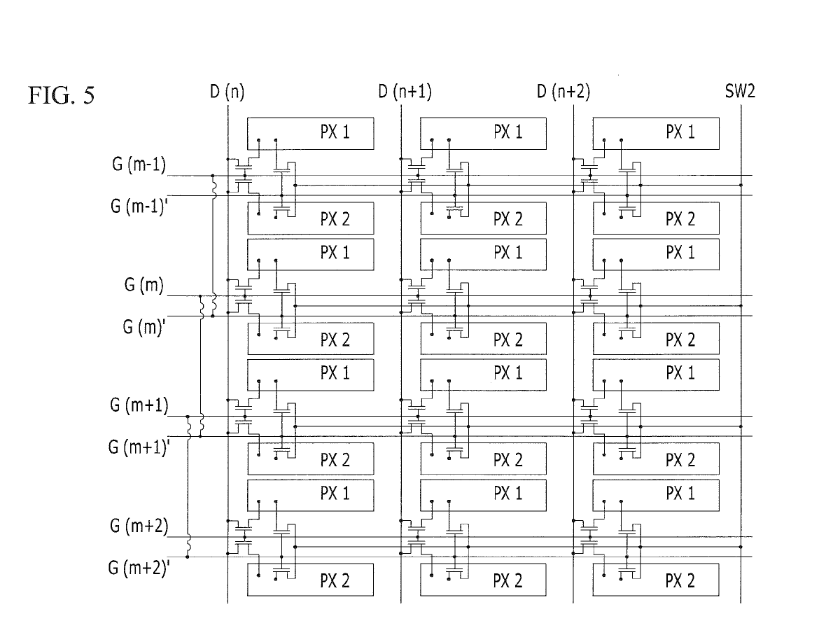

Hereinafter, referring to FIG. 5, layouts of another exemplary embodiment of signal lines and pixels of an exemplary LCD according to the present invention and an exemplary embodiment of a driving method thereof will be described. FIG. 5 is an equivalent circuit diagram of an exemplary embodiment of a plurality of adjacent pixels of an LCD according to the present invention.

Referring to FIG. 5, the layouts of the exemplary embodiment of the signal line and the pixel of the LCD are similar to those of the exemplary LCD shown in FIG. 3. Therefore, the same components will not be described.

The layouts of the exemplary embodiment of the signal line and the pixel of the LCD include a second voltage line SW2 which extends in parallel to the data lines D(n), D(n+1), and D(n+2), unlike the layouts of the signal line SW1 and the pixel of the exemplary LCD shown in FIG. 3. The second voltage line SW2 is connected to each pixel through the first switching element Qa and the second switching element Qb to apply the precharge voltage to each pixel.

Further, one second voltage line SW2 may be disposed for every a plurality of pixel columns, e.g., every three pixel columns. However, in alternative exemplary embodiments, one second voltage line SW2 may be disposed for every one or more pixel.

As described above, the first gate lines G(m−1)′, G(m)′, G(m+1)′, and G(m+2)′ for activating the switching elements for applying the precharge voltage to the pixels and the second gate lines G(m−1), G(m), G(m+1), and G(m+2) for activating the switching elements for applying the data voltage to the pixels are connected to the pixels.

The first gate lines G(m−1)′, G(m)′, G(m+1)′, and G(m+2)′ for activating the switching elements for applying the precharge voltage to the pixels are connected to the second gate lines G(m−1), G(m), G(m+1), and G(m+2) that are disposed at the previous stages, respectively, such as by a connector.

During the horizontal section where the gate voltage for activating the switching element for applying the data voltage to the previous-stage pixel, the precharge voltage that flows on the second voltage line SW2 is precharged with the current-stage pixel. During a subsequent horizontal section where the gate voltage for activating the switching element for applying the data voltage flows on the current-stage pixel, since up to a desired data value from the precharge voltage, up to the desired data value is charged by charging only voltage of predetermined intensity corresponding to the difference between the desired data value and the precharged precharge voltage in order to charge with the data voltage of the desired intensity. Therefore, a time when the pixel is charged with pixel voltage of desired intensity is reduced.

Further, since a previous-stage gate line is used to apply the precharge voltage without an additional gate driver, only the voltage line SW2 for transferring the precharge voltage and the simple driver for applying constant precharge voltage may be added without a complicated driver for applying the precharge voltage. As a result, the driving method may be simpler and a manufacturing cost may be decreased.

Further, as described above, since polarities of the precharge voltage and the data voltage applied to each pixel are the same as each other, according to the exemplary embodiment, data voltage of the same polarity is applied along the pixel column in the LCD. Therefore, data driving becomes simpler to reduce the load of a data driver.

Further, in this exemplary embodiment, since the signal line SW2 for transferring the precharge voltage is parallel to the data line and one signal line is disposed for every a plurality of columns, the aperture ratio of the LCD may be increased.

Although not shown, any one of the first pixel electrode PX1 and the second pixel electrode PX2 that are disposed in each pixel may include a voltage reducing unit or a voltage boosting unit for decreasing or increasing the intensity of charged voltage. As the voltage reducing unit or the voltage boosting unit, all possible structures including a capacitor, a resistor, a charging unit connected with the switching element, and the like may be used.

The intensity of the voltage charged in the first pixel electrode PX1 and the second pixel electrode PX2 disposed in each pixel may vary by including the voltage reducing unit or the voltage boosting unit. Therefore, the side visibility of a LCD of a vertically aligned mode in which long axes of liquid crystal molecules are arranged vertical to a display plate while no electric field is applied may be close to the front visibility.

In the shown exemplary embodiment, the first gate line for applying the precharge voltage is connected to the second gate line of the immediately previous stage, but in alternative exemplary embodiments, the first gate line may be connected to a predetermined previous-stage gate line. For example, a first gate line of an m-th pixel may be connected to second gate lines of m−1, m−2, m−3-th pixels, and the like.

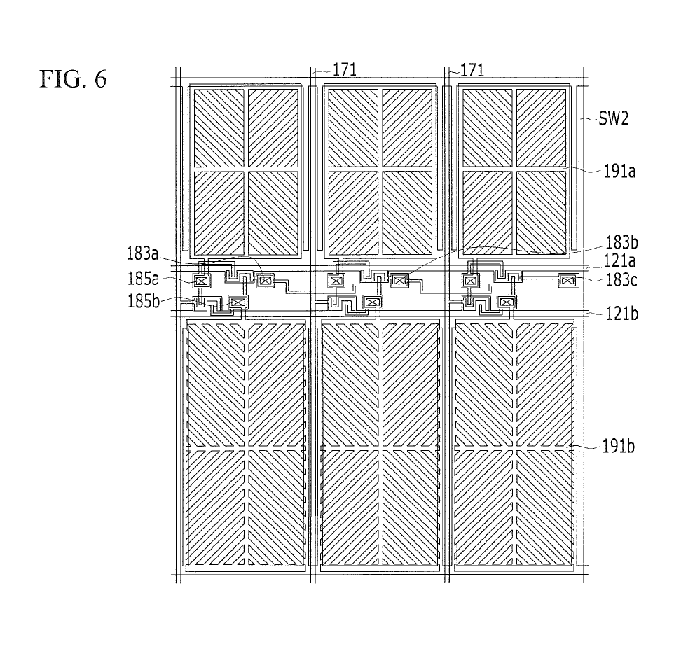

Hereinafter, referring to FIG. 6, an exemplary embodiment of a structure of the LCD shown in FIG. 5 will be described in brief. FIG. 6 is a plan view of an exemplary embodiment of some pixels of the LCD shown in FIG. 5.

Referring to FIG. 6, each pixel includes a first pixel electrode 191a and a second pixel electrode 191b and includes a data line 171, a first gate line 121a and a second gate line 121b, and a second voltage line SW2 that are connected to the first pixel electrode 191a and the second pixel electrode 191b. Further, and with reference in part to FIG. 4, each pixel includes a first gate electrode, a first source electrode and a second source electrode, a first drain electrode and a second drain electrode, and a first semiconductor that form the first switching element Qa and the second switching element Qb for applying the precharge voltage from the second voltage line SW2 to the first pixel electrode 191a and the second pixel electrode 191b and includes a second gate electrode, a third source electrode and a fourth source electrode, a third drain electrode and a fourth drain electrode, and a second semiconductor that form the third switching element Qc and the fourth switching element Qd for applying the data voltage from the data line 171 to the first pixel electrode 191a and the second pixel electrode 191b. The first drain electrode and the second drain electrode and the third drain electrode and the fourth drain electrode are connected to the first pixel electrode 191a and the second pixel electrode 191b through a first contact hole 185a and a second contact hole 185b. The first drain electrode and the second drain electrode and the second voltage line SW2 are connected to each other through third contact holes 183a, 183b, and 183c.

A lot of characteristics of the LCD shown in FIGS. 3 and 4 may all be applied to the LCD shown in FIGS. 5 and 6.

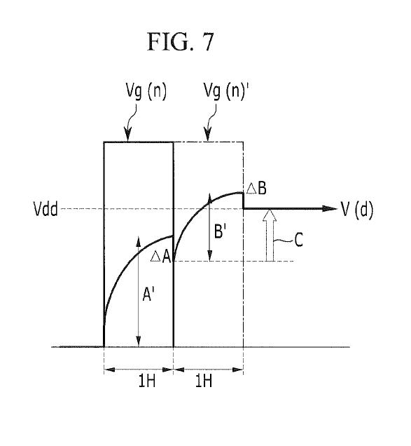

Hereinafter, referring to FIG. 7, a signal applied to another exemplary embodiment of an LCD according to the present invention will be described. FIG. 7 is a waveform diagram of a signal applied to an exemplary embodiment of an LCD according to the present invention.

Referring to FIG. 7, when a gate-on signal Vg(n) is applied to a third gate line, data voltage V(d) of predetermined intensity A′ is applied. The data voltage V(d) is partially reduced by kick-back voltage ΔA. Thereafter, when a gate-on signal Vg(n)′ is applied to a fourth gate line, boosting voltage of predetermined intensity B′ is applied and reduced by kick-back voltage ΔB. Like this, in high-speed driving in which the data voltage V(d) is applied for a short time, the application time of the data voltage V(d) is decreased, such that even though the data voltage V(d) is not sufficiently charged, the data voltage V(d) may be maintained to desired intensity Vdd by applying the boosting voltage B′.

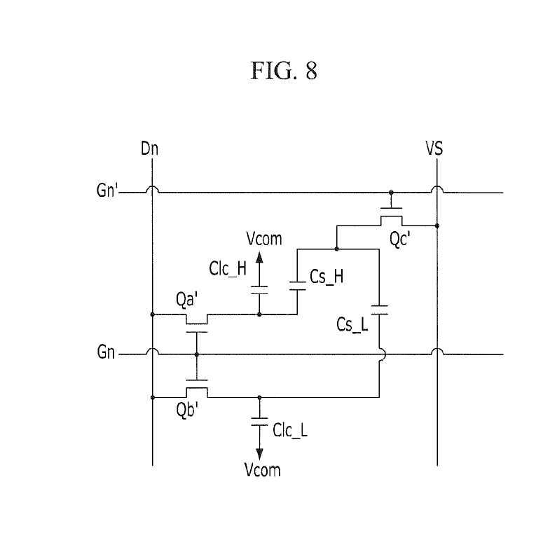

Hereinafter, referring to FIGS. 7 and 8, layouts of an exemplary embodiment of signal lines and pixels of the LCD described with respect to FIG. 7 and an exemplary embodiment of a driving method thereof will be described. FIG. 8 is an equivalent circuit diagram of an exemplary embodiment of one pixel of the LCD described with respect to FIG. 7.

Referring to FIG. 8, an exemplary embodiment of the LCD includes signal lines including a third gate line Gn and a fourth gate line Gn′, a data line Dn, and a third voltage line VS, a fifth switching element Qa′, a sixth switching element Qb′, and a seventh switching element Qc′ that are connected to the signal lines Gn, Gn′, Dn, and VS, and first and second liquid crystal capacitors Clc_H and Clc_L and first and second boosting capacitors Cs_H and Cs_L that are connected thereto.

The fifth switching element Qa′, the sixth switching element Qb′, and the seventh switching element Qc′ are three-terminal elements such as a TFT, and the like. Control terminals of the fifth switching element Qa′ and the sixth switching element Qb′ are connected to the third gate line Gn, input terminals of the fifth switching element Qa′ and the sixth switching element Qb′ are connected to the data line Dn, and output terminals of the fifth switching element Qa′ and the sixth switching element Qb′ are connected to the first and second liquid crystal capacitors Clc_H and Clc_L, respectively. A control terminal of the seventh switching element Qc′ is connected to the fourth gate line Gn′, an input terminal of the seventh switching element Qc′ is connected to the third voltage line VS, and an output terminal of the seventh switching element Qc′ is connected to one terminal of each of the first and second boosting capacitors Cs_H and Cs_L. The other one terminal of each of the first and second boosting capacitors Cs_H and Cs_L is connected to each of the first and second liquid crystal capacitors Clc_H and Clc_L, respectively. In an exemplary embodiment, the control terminal, input terminal, and output terminal of the fifth, sixth, and seventh switching elements Qa′, Qb′, and Qc′ may be a gate electrode, a source electrode, and a drain electrode, respectively.

First, when the gate-on signal Vg(n) is applied to the third gate line Gn, data voltage A′ that flows on the data line Dn is charged in the first and second liquid crystal capacitors Clc_H and Clc_L through the fifth switching element Qa′ and the sixth switching element Qb′. The data voltage A′ may be partially reduced by kick-back voltage ΔA. Thereafter, when the gate-on signal Vg(n)′ is applied to the fourth gate line Gn′, boosting voltage B′ is applied to one terminal of each of the first and second boosting capacitors Cs_H and Cs_L through the seventh switching element Qc′. In this case, each of the first and second liquid crystal capacitors Clc_H, Clc_L, that is the other one terminal of each of the first and second boosting capacitors Cs_H and Cs_L, is in a floating state on. Therefore, the boosting voltage B′, applied to terminals corresponding to the first and second boosting capacitors Cs_H and Cs_L, is charged in the first and second liquid crystal capacitors Clc_H, Clc_L which are in the floating state. Accordingly, although data voltage A′ is not applied for a sufficient time, such that data voltage of desired intensity Vdd is not charged, the data voltage A′ is boosted by applying the boosting voltage B′, thereby maintaining the data voltage of the desired intensity Vdd.

The boosting voltage B′ has the same polarity as the data voltage A′. In an exemplary embodiment in which the data voltage A′ is frame-inverted, the boosting voltage B′ may be frame-inverted like the data voltage A′. That is, in an embodiment in which the data voltage A′ has a positive polarity, the boosting voltage B′ may also have the positive polarity and in an embodiment in which the data voltage A′ has a negative polarity, the boosting voltage B′ may also have the negative polarity.

Like this, in the exemplary embodiment of the LCD according to the present invention, the boosting voltage B′ is applied to each pixel through the third voltage line VS for applying voltage of predetermined intensity Vdd. Although a voltage line and a driver for applying the precharge voltage are added, since the boosting voltage has the predetermined intensity, only a simple driver for applying predetermined voltage is added. As a result, a driving method may be simple and a manufacturing cost may be small.

Although not shown, the first and second liquid crystal capacitors Clc_H and Clc_L may be connected to the first pixel electrode and the second pixel electrode that form one pixel and any one of the first pixel electrode and the second pixel electrode may include a voltage reducing unit or a voltage boosting unit for decreasing or increasing the intensity of charged voltage. As the voltage reducing unit or the voltage boosting unit, all possible structures including a capacitor, a resistor, a charging unit connected with the switching element, and the like may be used.

The intensity of the voltage charged in the first pixel electrode PX1 and the second pixel electrode PX2 disposed in each pixel may vary by including the voltage reducing unit or the voltage boosting unit. Therefore, the side visibility of an LCD of a vertically aligned mode in which long axes of liquid crystal molecules are arranged vertical to a display plate while no electric field is applied may be close to the front visibility.

In an exemplary embodiment, the intensity of the voltage charged in the first pixel electrode may be larger than that of the voltage charged in the second pixel electrode. In such an exemplary embodiment, the size of the second pixel electrode may be larger than that of the first pixel electrode. Further, in such an exemplary embodiment, a ratio of the capacitance of the first boosting capacitor to an area of the first pixel electrode is preferably approximately 1.2 times larger than a ratio of the capacitance of the second boosting capacitor to an area of the second pixel electrode. As a result, the larger boosting voltage is charged in a pixel electrode charged with high voltage, such that the voltage drop of a pixel electrode having large voltage drop may be reduced by the kick-back voltage.

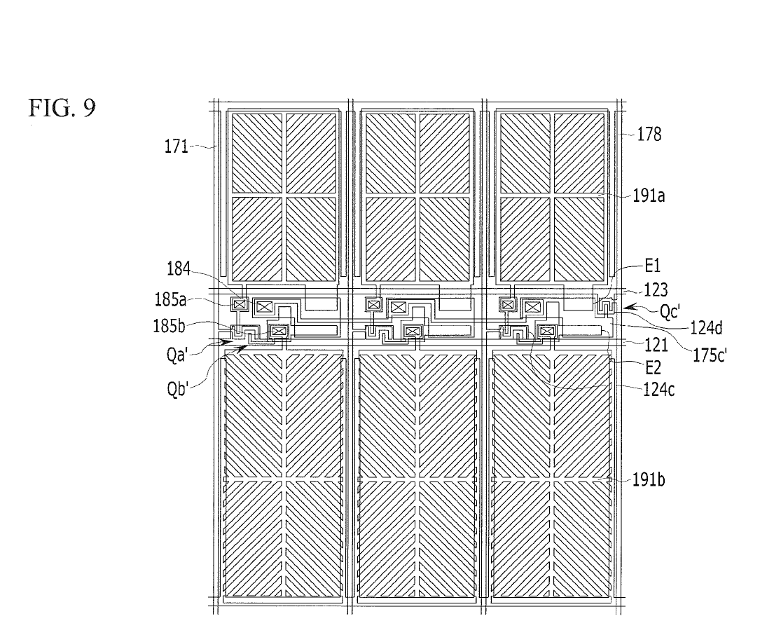

Hereinafter, referring to FIG. 9, a structure of an exemplary embodiment of the LCD according to the exemplary embodiment shown in FIG. 8 will be described in brief. FIG. 9 is a plan view of an exemplary embodiment of three pixels of the LCD according to the exemplary embodiment shown in FIG. 8.

Referring to FIG. 9, each pixel includes a first pixel electrode 191a and a second pixel electrode 191b and includes a data line 171, a third gate line 121 and a fourth gate line 123, and a third voltage line 178 that are connected to the first pixel electrode 191a and the second pixel electrode 191b.

Each pixel includes a third gate electrode 124c, a fifth source electrode and a sixth source electrode, and a fifth drain electrode and a sixth drain electrode that form a fifth switching element Qa′ and a sixth switching element Qb′ for applying data voltage from the data line 171 to the first pixel electrode 191a and the second pixel electrode 191b, where the fifth and sixth switching elements Qa′ and Qb′ are connected to the first and second pixel electrodes 191a and 191b via the contact holes 185a and 185b, respectively. Further, each pixel includes a fourth gate electrode 124d, a seventh source electrode, and a seventh drain electrode 175c′ that form a seventh switching element Qc′ for applying boosting voltage from the third voltage line 178 to the first pixel electrode 191a and the second pixel electrode 191b. The seventh drain electrode 175c′ is overlapped with extension portions E1 and E2 of the first pixel electrode 191a and the second pixel electrode 191b to form the first and second boosting capacitors Cs_H and Cs_L.

In the illustrated exemplary embodiment, portions forming terminals of the first and second boosting capacitors Cs_H and Cs_L of a plurality of adjacent pixels are connected to each other through a contact hole 184 to thereby apply the boosting voltage to the plurality of pixels at the same time. In the exemplary embodiment, the boosting voltage may be applied to three adjacent pixel columns from one third voltage line 178 at the same time. As a result, the number of signal lines for applying the boosting voltage is decreased to thereby increase the aperture ratio of the LCD. However, in another exemplary embodiment of the present invention, the boosting voltage may be applied to one or more pixel columns from one boosting voltage line at the same time.

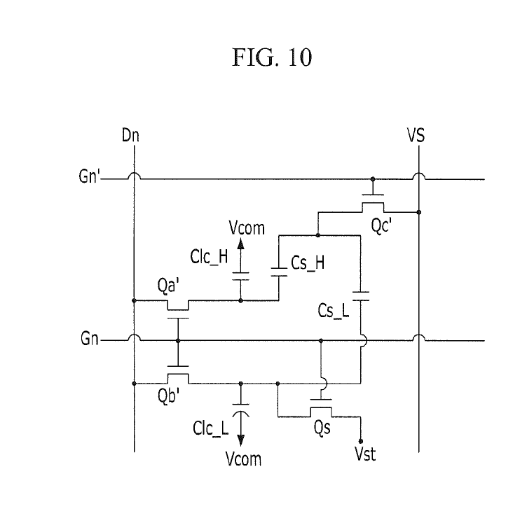

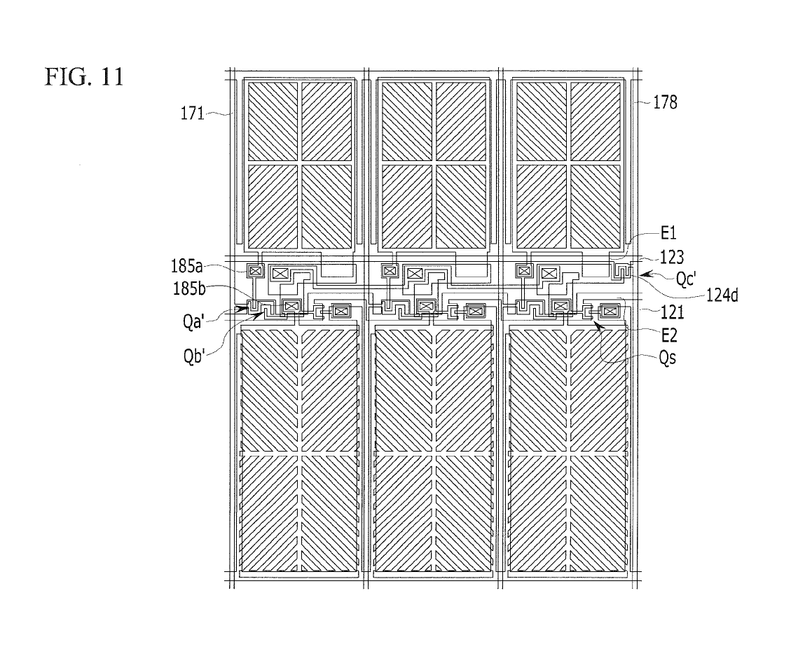

Hereinafter, referring to FIGS. 10 and 11, another exemplary embodiment of an LCD according to the present invention will be described. FIG. 10 is an equivalent circuit diagram of another exemplary embodiment of one pixel of an LCD according to the present invention and FIG. 11 is a plan view of an exemplary embodiment of three pixels of the LCD shown in FIG. 10.

Referring to FIGS. 10 and 11, the LCD according to the exemplary embodiment may include the layout of the signal line and the layout of the pixel substantially similar to the exemplary embodiment of an LCD shown in FIGS. 8 and 9. Therefore, the same components will not be described.

However, the exemplary embodiment of the LCD shown in FIGS. 10 and 11 includes an additional voltage reducing switching element Qs for reducing the voltage charged in the second liquid crystal capacitor Clc_L unlike the exemplary embodiment of an LCD shown in FIGS. 8 and 9. Since an input terminal of the voltage reducing switching element Qs is connected to the second liquid crystal capacitor Clc_L, an electric charge of the same intensity is charged in the first liquid crystal capacitor Clc_H and the second liquid crystal capacitor Clc_L, and the electric charge charged in the second liquid crystal capacitor Clc_L is partially moved through an output terminal of the voltage reducing switching element Qs. As a result, the intensity of voltage charged in the second liquid crystal capacitor Clc_L is smaller than that of voltage charged in the first liquid crystal capacitor Clc_H.

A lot of characteristics of the LCD shown in FIGS. 8 and 9 may be applied to the exemplary embodiment of the LCD shown in FIGS. 10 and 11, and therefore a detailed description of the common elements will not be repeated.

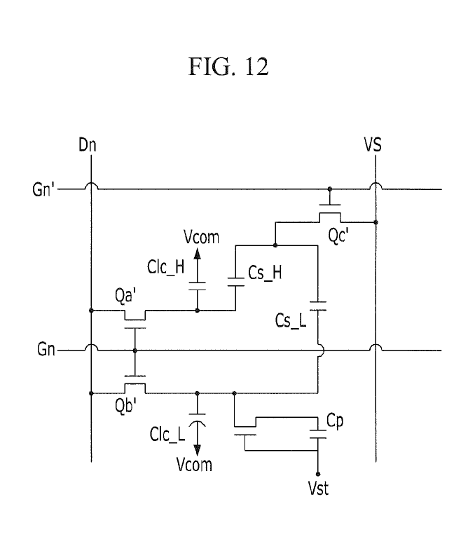

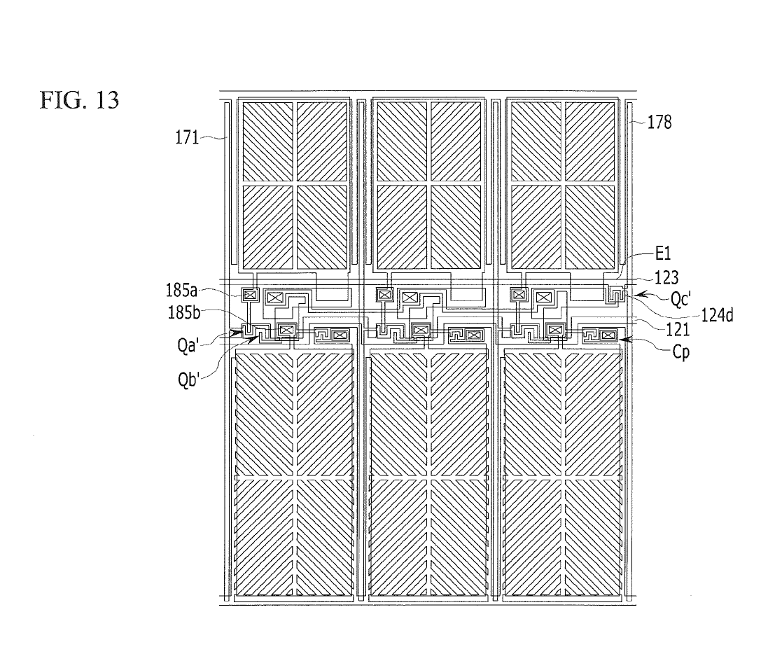

Hereinafter, referring to FIGS. 12 and 13, another exemplary embodiment of an LCD according to the present invention will be described. FIG. 12 is an equivalent circuit diagram of another exemplary embodiment of one pixel of an LCD according to the present invention and FIG. 13 is a plan view of an exemplary embodiment of three pixels of the LCD shown in FIG. 12.

Referring to FIGS. 12 and 13, an exemplary embodiment of an LCD includes the layout of the signal line and the layout of the pixel substantially similar to the exemplary embodiment of the LCD shown in FIGS. 8 and 9. Therefore, the same components will not be described.

However, the exemplary embodiment of the LCD of FIGS. 12 and 13 includes an additional voltage reducing capacitor CP for reducing the voltage charged in the second liquid crystal capacitor Clc_L, unlike the exemplary embodiment of the LCD shown in FIGS. 8 and 9. Since one terminal of the voltage reducing capacitor CP is connected to the second liquid crystal capacitor Clc_L, an electric charge of the same intensity is charged in the first liquid crystal capacitor Clc_H and the second liquid crystal capacitor Clc_L, and the electric charge charged in the second liquid crystal capacitor Clc_L is partially moved to one terminal of the voltage reducing capacitor CP. As a result, the intensity of voltage charged in the second liquid crystal capacitor Clc_L is smaller than that of voltage charged in the first liquid crystal capacitor Clc_H.

A lot of characteristics of the LCD shown in FIGS. 8 and 9 may be applied to the exemplary embodiment of the LCD shown in FIGS. 12 and 13, and therefore a detailed description of the common elements will not be repeated.

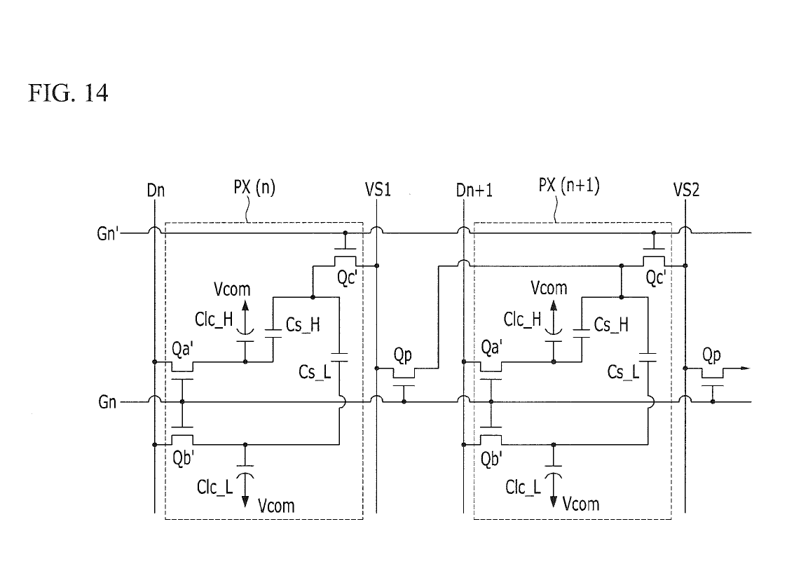

Hereinafter, referring to FIG. 14, another exemplary embodiment of an LCD according to the present invention will be described. FIG. 14 is an equivalent circuit diagram of another exemplary embodiment of one pixel of an LCD according to the present invention.

Referring to FIG. 14, the layouts of the signal line and the pixel of the exemplary embodiment of the LCD are similar to those of the exemplary embodiment of the LCD shown in FIG. 8.

The exemplary embodiment of the LCD of FIG. 14 includes two pixels PX(n) and PX(n+1) that are adjacent to each other. Since the layout of each of the pixels PX(n) and PX(n+1) is similar to that of the exemplary embodiment of the LCD shown in FIG. 8, the same components will not be described.

Boosting voltages of different polarities may be applied to a fourth signal line VS1 and a fifth signal line VS2 for applying the boosting voltage to two pixels PX(n) and PX(n+1) that are adjacent to each other.

The exemplary embodiment of the LCD shown in FIG. 14 further includes a reset switching element Qp connected to the third gate line Gn. An input terminal of the reset switching element Qp is the fourth signal line VS1 or the fifth signal line VS2 connected to the adjacent respective pixels and applies the boosting voltage to the adjacent pixels, and an output terminal of the reset switching element Qp is connected to one terminal of each of the boosting capacitors Cs_H and Cs_L. Therefore, when data voltage is charged in the first pixel PX(n) of two pixels PX(n), PX(n+1), the voltage that flows on the fourth signal line VS1 is charged in the boosting capacitors Cs_H, Cs_L of the second pixel PX(n+1). The polarity of the voltage that flows on the fourth signal line VS1 is opposite to the polarities of the data voltage and the boosting voltage applied to the second pixel PX(n+1) through the data line Dn+1 and the fifth signal line VS2. Like this, before the boosting voltage is applied to the second pixel PX(n+1), the first and second boosting capacitors Cs_H and Cs_L are precharged with voltage having the opposite polarity from the signal line for applying the boosting voltage to the first pixel PXn to be reset, thereby accurately maintaining the intensity of the boosting voltage applied to the first and second boosting capacitors Cs_H and Cs_L.

A lot of characteristics of the LCD shown in FIGS. 8 and 9 may be applied to the exemplary embodiment of the LCD shown in FIG. 14, and therefore a detailed description of the common elements will not be repeated.

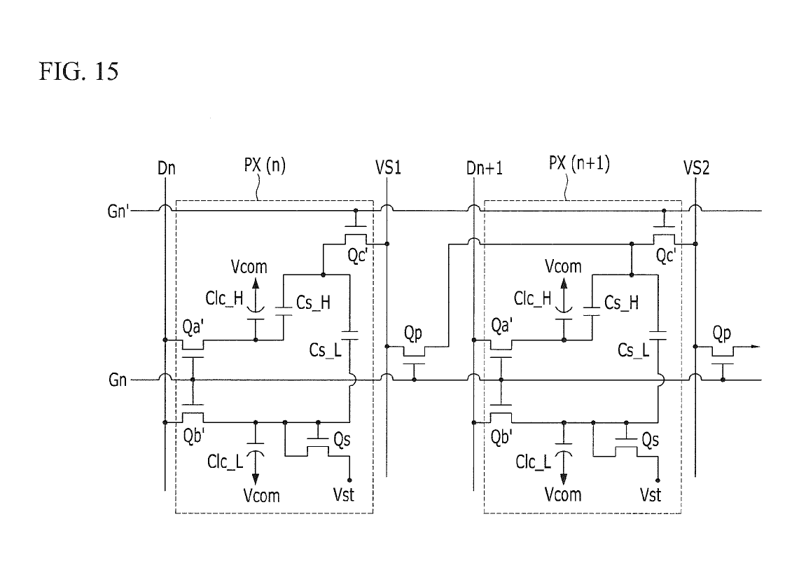

Hereinafter, referring to FIG. 15, another exemplary embodiment of an LCD according to the present invention will be described. FIG. 15 is an equivalent circuit diagram of another exemplary embodiment of one pixel of an LCD according to the present invention.

Referring to FIG. 15, the exemplary embodiment of the LCD includes the layout of the signal line and the layout of the pixel substantially similar to the exemplary embodiment of LCD shown in FIG. 14. Therefore, the same components will not be described.

However, the exemplary embodiment of the LCD of FIG. 15 includes an additional voltage reducing switching element Qs for reducing the voltage charged in the second liquid crystal capacitor Clc_L, unlike the exemplary embodiment of the LCD shown in FIG. 14. Since an input terminal of the voltage reducing switching element Qs is connected to the second liquid crystal capacitor Clc_L, an electric charge of the same intensity is charged in the first liquid crystal capacitor Clc_H and the second liquid crystal capacitor Clc_L and the electric charge charged in the second liquid crystal capacitor Clc_L is partially moved through an output terminal of the voltage reducing switching element Qs. As a result, the intensity of voltage charged in the second liquid crystal capacitor Clc_L is smaller than that of voltage charged in the first liquid crystal capacitor Clc_H.

A lot of characteristics of the LCD shown in FIGS. 8 and 9, a lot of characteristics of the LCD shown in FIGS. 10 and 11, and a lot of characteristics of the LCD shown in FIG. 14 may be applied to the exemplary embodiment of the LCD shown in FIG. 15, and therefore a detailed description of the common elements will not be repeated.

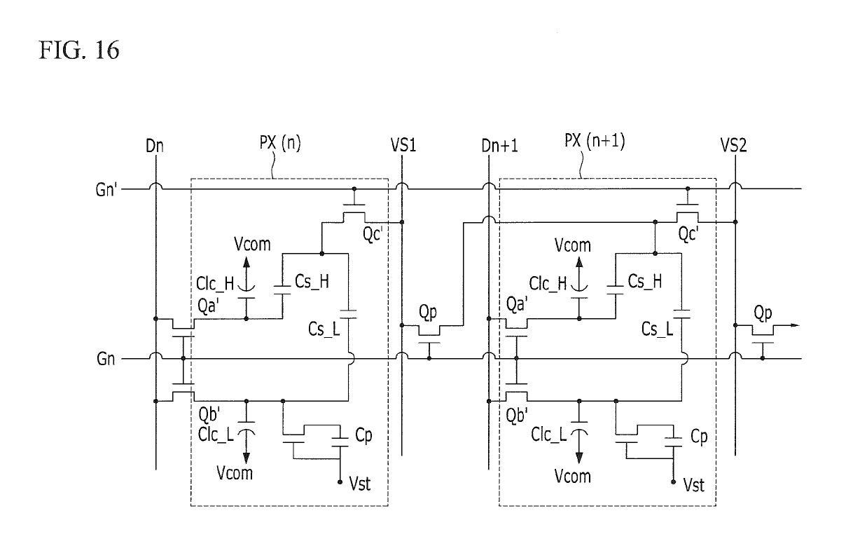

Hereinafter, referring to FIG. 16, another exemplary embodiment of an LCD according to the present invention will be described. FIG. 16 is an equivalent circuit diagram of another exemplary embodiment of one pixel of an LCD according to the present invention.

Referring to FIG. 16, the exemplary embodiment of the LCD includes a layout of the signal line and a layout of the pixel substantially similar to the exemplary embodiment of the LCD shown in FIG. 14. Therefore, the same components will not be described.

However, the exemplary embodiment of the LCD includes an additional voltage reducing capacitor CP for reducing the voltage charged in the second liquid crystal capacitor Clc_L, unlike the exemplary embodiment of the LCD shown in FIG. 14. Since one terminal of the voltage reducing capacitor CP is connected to the second liquid crystal capacitor Clc_L, an electric charge of the same intensity is charged in the first liquid crystal capacitor Clc_H and the second liquid crystal capacitor Clc_L and the electric charge charged in the second liquid crystal capacitor Clc_L is partially moved to one terminal of the voltage reducing capacitor CP. As a result, the intensity of voltage charged in the second liquid crystal capacitor Clc_L is smaller than that of voltage charged in the first liquid crystal capacitor Clc_H.

A lot of characteristics of the LCD shown in FIGS. 8 and 9, a lot of characteristics of the LCD shown in FIGS. 12 and 13, and a lot of characteristics of the LCD shown in FIG. 14 may be applied to the LCD according to the exemplary embodiment of FIG. 16, and therefore a detailed description of the common elements will not be repeated.

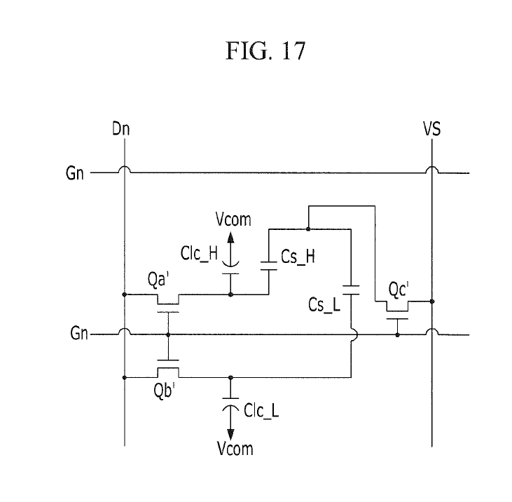

Hereinafter, referring to FIG. 17, a LCD according to another exemplary embodiment of the present invention will be described. FIG. 17 is an equivalent circuit diagram of one pixel of a LCD according to another exemplary embodiment of the present invention.

Referring to FIG. 17, the LCD according to the exemplary embodiment includes signal lines including a third gate line Gn, a data line Dn, and a third voltage line VS, a fifth switching element Qa′, a sixth switching element Qb′, and a seventh switching element Qc′ that are connected to the signal lines Gn, Dn, and VS, and first and second liquid crystal capacitors Clc_H and Clc_L and first and second boosting capacitors Cs_H and Cs_L that are connected thereto.

The fifth switching element Qa′, the sixth switching element Qb′, and the seventh switching element Qc′ are three-terminal elements such as a TFT, and the like. Control terminals of the fifth switching element Qa′, the sixth switching element Qb′, and the seventh switching element Qc′ are connected to the third gate line Gn, input terminals of the fifth switching element Qa′ and the sixth switching element Qb′ are connected to the data line Dn, and output terminals of the fifth switching element Qa′ and the sixth switching element Qb′ are connected to the first and second liquid crystal capacitors Clc_H and Clc_L, respectively. An input terminal of the seventh switching element Qc′ is connected to the third voltage line VS and an output terminal of the seventh switching element Qc′ is connected to one terminal of each of the first and second boosting capacitors Cs_H, Cs_L. The other one terminal of each of the first and second boosting capacitors Cs_H and Cs_L is connected to each of the first and second liquid crystal capacitors Clc_H, Clc_L, respectively. In an exemplary embodiment, the control terminal, input terminal, and output terminal of the fifth, sixth, and seventh switching elements Qa′, Qb′, and Qc′ may be a gate electrode, a source electrode, and a drain electrode, respectively.

When the gate-on signal Vg(n) is applied to the third gate line Gn, data voltage that flows on the data line Dn is charged in the first and second liquid crystal capacitors Clc_H and Clc_L through the fifth switching element Qa and the sixth switching element Qb′ and boosting voltage B′ is applied to one terminal of each of the first and second boosting capacitors Cs_H and Cs_L through the seventh switching element Qc′. Like this, by applying the data voltage and the boosting voltage through one gate line, the aperture ratio of the LCD may be increased.

The layouts of the signal line and pixel of the exemplary embodiment of the LCD of FIG. 17 and the driving methods thereof may be applied to all types of pixel structures.

According to an exemplary embodiment of the present invention, it is possible to charge data voltage of sufficient intensity even in high-speed driving by precharging with predetermined voltage before applying actual data voltage.

According to another exemplary embodiment of the present invention, by applying boosting voltage by using a boosting capacitor after applying the actual data voltage, it is possible to charge the data voltage of the sufficient intensity even when a charging time is insufficient by high-speed driving.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first substrate and a second substrate facing each other;
a liquid crystal layer interposed between the first and second substrates and including liquid crystal molecules;
a first gate line and a second gate line formed on the first substrate and transferring gate signals;
a first voltage line formed on the first substrate and transferring voltage of predetermined intensity;
a data line formed on the first substrate and transferring a data signal;
a first switching element connected to the first gate line and the first voltage line;
a second switching element connected to the second gate line and the data line; and
a pixel electrode connected to the first switching element and the second switching element,
wherein a gate-on signal is applied to the first gate line earlier than the second gate line.

2. The liquid crystal display of claim 1, wherein:
the first gate line is connected to a gate line disposed at a previous stage.

3. The liquid crystal display of claim 2, wherein:
polarities of voltages that flow on the first voltage line and the data line are the same as each other.

4. The liquid crystal display of claim 3, wherein:
an intensity of the voltage that flows on the first voltage line is about 0.9 to about 1.0 times larger than that of the voltage that flows on the data line.

5. The liquid crystal display of claim 4, wherein:
the pixel electrode includes a first pixel electrode and a second pixel electrode, and
an intensity of voltage charged in the first pixel electrode is larger than an intensity of voltage charged in the second pixel electrode.

6. The liquid crystal display of claim 5, wherein:
the first voltage line is parallel to the first gate line and the second gate line.

7. The liquid crystal display of claim 5, wherein:
the first voltage line is parallel to the data line.

8. The liquid crystal display of claim 7, further comprising:
one first voltage line disposed in every a plurality of pixels.

9. The liquid crystal display of claim 1, wherein:
polarities of voltages that flow on the first voltage line and the data line are the same as each other.

10. The liquid crystal display of claim 9, wherein:
an intensity of the voltage that flows on the first voltage line is about 0.9 to about 1.0 times larger than that of the voltage that flows on the data line.

11. The liquid crystal display of claim 10, wherein:
the pixel electrode includes a first pixel electrode and a second pixel electrode, and
an intensity of voltage charged in the first pixel electrode is larger than an intensity of voltage charged in the second pixel electrode.

12. The liquid crystal display of claim 11, wherein:
the first voltage line is parallel to the first gate line and the second gate line.

13. The liquid crystal display of claim 11, wherein:
the first voltage line is parallel to the data line.

14. The liquid crystal display of claim 13, further comprising:
one first voltage line disposed in every a plurality of pixels.

15. The liquid crystal display of claim 1, wherein:
an intensity of voltage that flows on the first voltage line is about 0.9 to about 1.0 times larger than an intensity of voltage that flows on the data line.

16. The liquid crystal display of claim 15, wherein:
the pixel electrode includes a first pixel electrode and a second pixel electrode, and
an intensity of voltage charged in the first pixel electrode is larger than an intensity of voltage charged in the second pixel electrode.

17. The liquid crystal display of claim 16, wherein:
the first voltage line is parallel to the first gate line and the second gate line.

18. The liquid crystal display of claim 16, wherein:
the first voltage line is parallel to the data line.

19. The liquid crystal display of claim 18, further comprising:
one first voltage line disposed in every a plurality of pixels.

20. The liquid crystal display of claim 1, wherein:
the pixel electrode includes a first pixel electrode and a second pixel electrode, and
an intensity of voltage charged in the first pixel electrode is larger than an intensity of voltage charged in the second pixel electrode.

21. The liquid crystal display of claim 20, wherein:
the first voltage line is parallel to the first gate line and the second gate line.

22. The liquid crystal display of claim 20, wherein:
the first voltage line is parallel to the data line.

23. The liquid crystal display of claim 22, further comprising:
one first voltage line disposed in every a plurality of pixels.

24. The liquid crystal display of claim 1, wherein:
the first voltage line is parallel to the first gate line and the second gate line.

25. The liquid crystal display of claim 1, wherein:
the first voltage line is parallel to the data line.

26. The liquid crystal display of claim 25, further comprising:
one first voltage line disposed in every a plurality of pixels.

27. A liquid crystal display, comprising:
a first substrate and a second substrate facing each other;
a liquid crystal layer interposed between the first and second substrates and including liquid crystal molecules;
a first gate line and a second gate line formed on the first substrate and transferring gate signals;
a first voltage line formed on the first substrate and transferring voltage of predetermined intensity;
a data line formed on the first substrate and transferring a data signal;
a first switching element connected to the first gate line and the data line;
a second switching element connected to the second gate line and the first voltage line;
a pixel electrode connected to the first switching element; and
a capacitor connected to the pixel electrode and the second switching element,
wherein after a gate-on signal is applied to the first gate line, the gate-on signal is applied to the second gate line.

28. The liquid crystal display of claim 27, wherein:
the pixel electrode includes a first pixel electrode and a second pixel electrode, and
an intensity of voltage charged in the first pixel electrode is larger than an intensity of voltage charged in the second pixel electrode.

29. The liquid crystal display of claim 28, wherein:
the capacitor includes a first capacitor including the first pixel electrode and the first voltage line as both terminals and a second capacitor including the second pixel electrode and the first voltage line as both terminals.

30. The liquid crystal display of claim 29, wherein:
a size of the first pixel electrode is smaller than a size of the second pixel electrode, and
a ratio of capacitance of the first capacitor to an area of the first pixel electrode is about 1.2 times larger than a ratio of capacitance of the second capacitor to an area of the second pixel electrode.

31. The liquid crystal display of claim 30, further comprising:
a second voltage line transferring voltage of predetermined intensity having a polarity different from the voltage which the first voltage line transfers; and
a third switching element connected to the first gate line and the second voltage line,
wherein an output terminal of the third switching element is connected to a capacitor in an adjacent pixel.

32. The liquid crystal display of claim 31, wherein:
polarities of voltages that flow on the first voltage line and the data line are the same as each other.

33. The liquid crystal display of claim 27, further comprising:
a second voltage line transferring voltage of predetermined intensity having a polarity different from the voltage which the first voltage line transfers; and
a third switching element connected to the first gate line and the second voltage line,
wherein an output terminal of the third switching element is connected to a capacitor of an adjacent pixel.

34. The liquid crystal display of claim 33, wherein:
polarities of voltages that flow on the first voltage line and the data line are the same as each other.

35. The liquid crystal display of claim 27, wherein:
polarities of voltages that flow on the first voltage line and the data line are the same as each other.

36. A liquid crystal display, comprising:
a first substrate and a second substrate facing each other;
a liquid crystal layer interposed between the first and second substrates and including liquid crystal molecules;
a gate line formed on the first substrate and transferring gate signals;
a first voltage line formed on the first substrate and transferring voltage of predetermined intensity;
a data line formed on the first substrate and transferring a data signal;
a first switching element connected to the gate line and the data line;
a second switching element connected to the gate line and the first voltage line;
a pixel electrode connected to the first switching element; and
a capacitor connected to the pixel electrode and the second switching element.

37. A method of driving a liquid crystal display, the method comprising:
receiving a gate-on signal from a gate line in a previous stage;
outputting the gate-on signal to a first gate line connected to a current pixel in a first horizontal section;
transferring voltage of a predetermined intensity to a pixel electrode of the current pixel in the first horizontal section via a first switching element connected to a first voltage line and the first gate line;
outputting a gate-on signal to a second gate line connected to the current pixel in a second horizontal section, subsequent the first horizontal section; and,
applying a data voltage to the pixel electrode in the second horizontal section via a second switching element connected to a data line and the second gate line.

38. A method of driving a liquid crystal display, the method comprising:
applying a gate-on signal to a first gate line;
transferring data voltage of predetermined intensity to a pixel electrode via a first switching element connected to the first gate line and a data line;
applying a gate-on signal to a second gate line, subsequent to applying the gate-on signal to the first gate line;
transferring a boosting voltage of predetermined intensity to the pixel electrode via a boosting capacitor connected to a second switching element, which is connected to the second gate line and a first voltage line, the first voltage line transferring the boosting voltage of a same polarity as the data voltage.
